(19) United States
(12) Patent Application Publication
(10) Pub. No.: US 2002/0096962 A1
(43) Pub. Date: Jul. 25, 2002

(54) Spindle motor

(76) Inventors: Ryoji Yoneyama, Chiba-shi (JP); Shinji Kinoshita, Chiba-shi (JP); Hiromitsu Goto, Chiba-shi (JP); Toru Kumagai, Chiba-shi (JP); Yukihiro Nakayama, Chiba-shi (JP); Chihiro Tazawa, Chiba-shi (JP); Mitsuharu Iwamoto, Chiba-shi (JP)

Correspondence Address: ADAMS & WILKS, 31st Floor, 50 Broadway, New York, NY, 10004, US

(21) Appl. No.: 09/996,829

(22) Filed: Nov. 29, 2001

(30) Foreign Application Priority Data
Nov. 30, 2000 (JP) 2000-365594

(51) Int. Cl. H02K 1/06

(52) U.S. Cl. 310/217; 310/67 R

(57) ABSTRACT

In a spindle motor, a core with a specified thickness is formed by laminating thinnest possible magnetic steel sheets to allow consumed current to be reduced. For example, by providing a structure of a core of a spindle motor with seven 0.2 mm thick steel sheets being laminated, it becomes possible to make consumed current smaller than that for a core laminated with four 0.35 mm thick steel sheets. Thus, a spindle motor is provided as being suited for downsizing an HDD and possible to reduce consumed power.

### BACKGROUND OF THE INVENTION

1. Field of the Invention

The present invention relates to a structure of a spindle motor for a thin HDD device, and particularly to a structure useful for providing a spindle motor with small electric power consumption.

2. Description of the Related Art

In general, a bearing of a mass produced motor has a structure of supporting a motor shaft by using ball bearings. In such a bearing, however, steel balls as ball bearings, being in a state of rotating on a shaft or a support in principle, tend to generate noise. In particular, in an information home appliance mounted with an EDD (hard disk drive) recently becoming denser, a motor for driving the HDD at a higher speed generates larger noise from the bearing to cause a noise problem. Moreover, a bearing using the ball bearing tends to cause a large NRRO (non-resonant rotary oscillation). This causes read/write error in an HDD becoming denser.

Therefore, in recent years, development work is increasing about a bearing known as a hydraulic bearing (or a dynamic pressure bearing) in which oil is used as a lubricant. In the hydraulic bearing, a lubricating oil filling a space between a shaft and a sleeve (a supporter of the shaft) provides a rotation without causing the both to contact with each other. This hardly produces noise in principle with a trace of the rotating shaft being almost round to cause a considerably smaller NRRO compared with that of the bearing with the ball bearings.

FIG. 1 is a cross sectional views showing a principal part of a related spindle motor. The spindle motor 200 is provided with a hydraulic bearing assembled with the following being taken as prime components, a sleeve (a support) 1 formed with a shaft body inserting hole 1a, a frame 2 securing the lower side of the sleeve 1, a cylindrical shaft body 3 having a cross sectional form of an inverted T and being inserted into a space formed by the shaft body inserting hole 1a of the sleeve 1, the sleeve 1 and the frame 2, with a clearance being created between the shaft body 3 and inner walls of the sleeve 1 and the frame 2, a hub 4 mounted on an upper side of the shaft body 3 protruded through the sleeve 1, and oil 5 filling the above clearance.

In addition, the spindle motor 200 comprises a core 6 and coil 7 disposed on the periphery of the sleeve 1, and a magnet 8 mounted on the hub 4 and positioned so as to face the core 6 and the coil 7. The spindle motor 200 functions so that a varying magnetic field generated by the core 6 and the coil 7 acts on the magnet 8 to rotate the hub 4 with resulting rotation of the shaft body 3.

The core 6 has a structure in which a plurality of core materials 6a are laminated the prime material of which is a doughnut-like magnetic steel sheet. For the core material 6a in the related art, 0.35 mm thick magnetic steel sheets generally much in demand were used with fore sheets of them being laminated to constitute the core 6.

In recent years, development is being carried out so that the HDD is mounted on a portable information device. This requires to downsize the spindle motor as a power source for the HDD. Meanwhile, for an electric power supply, a battery is used with which a stable electric supply for a long service is difficult. Hence, smallest possible consumed power is required for electronic parts to be mounted to make it necessary for the consumed power of the spindle motor to be also made as being smallest possible. Therefore, in the related art, based on a generally known fact that a core with a larger volume consumes less power, the core volume must be enlarged for reducing power consumption. In addition, in the related art, mounting of a spindle motor on a portable information device was not so seriously considered that the spindle motor was mainly used for a device which allows a stable power to be supplied from a stable electric supply. Thus, developers of the spindle motor were not so conscious of power consumption of the spindle motor.

In the spindle motor in the related art, however, a structure was provided for reducing consumed power simply by enlarging the core volume to cause the spindle motor itself to be upsized. Thus, such a problem arose that the spindle motor was not suited for being downsized as a portable information device and imposed limitations on design of downsizing the spindle motor.

Conversely, a design for reducing a core volume so as to conform with downsizing with a structure of a spindle motor in the related art resulted in an increase in consumed power to cause a problem of shortened battery life.

Accordingly, the present invention was made in view of the foregoing with an object of providing a spindle motor which is suited for downsizing an HDD and can realize reduction in consumed power.

### SUMMARY OF THE INVENTION

In order to achieve the above object, a spindle motor according to the present invention is characterized in that, in a spindle motor comprising a body of rotation rotating with an axis of rotation thereof being centered; a magnet mounted on the body of rotation for making the body of rotation rotate by an action of a varying magnetic field; a coil generating the varying magnetic field acting on the magnet; and a core formed by laminating a plurality of doughnut-i ike magnetic steel sheets each with a plurality of protrusions provided on a periphery for winding wire of the coil, the core with a specified thickness is formed by laminating thinnest possible magnetic steel sheets. In particular, it is preferable for the thinnest possible magnetic steel sheet forming the core to have a thickness of 0.2 mm. Here, for the magnetic steel sheet, a non-oriented magnetic steel sheet can be used. In addition to this, there can be also used a high permeability alloy steel sheet such as a silicon steel sheet.

It is preferable that the magnetic steel sheet is provided with a plurality of riveting portions at each of which an indentation is provided on one side of the steel sheet to form a projection on the other side, and at each of the riveting portions, the projection on one magnetic steel sheet is fitted to the indentation of another magnetic steel sheet for being riveted to thereby make up a laminated structure of the magnetic steel sheets for the core. The riveting portions can ensure lamination of the magnetic steel sheets.

The magnetic steel sheet is made to have a thickness of 0.2 mm because it was found that thinner thickness of the magnetic steel sheet forming the core makes consumed power, i.e. consumed current, less as will be explained in detail in the description of a preferred embodiment. The thickness of 0.2 mm is preferable because the thickness is the lower limit for currently available magnetic steel sheet in providing adequate strength for forming the riveting section

Moreover, the consumed current is decreased because an eddy current, induced as shown in FIG. 2 in the core 9 in a direction for opposing induction of a magnetic flux Φ when a current I is made to flow in the coil 7 wound around the core 9, is reduced in thin magnetic steel sheets to decrease magnetic loss. That is, according to the present invention, increased resistance by using insulated thin core material can reduce the eddy current value to make it possible to suppress a consumed current in the motor.

From the foregoing, when forming, the core by laminating a plurality of magnetic steel sheets to a specified total thickness, it is preferable to select the thinnest possible magnetic steel sheets because the use of the sheets reduces consumed power.

### BRIEF DESCRIPTION OF THE DRAWINGS

FIG 1 is a cross sectional view showing a principal part of a related spindle motor;

FIG. 2 is an explanatory diagram showing an eddy current loss;

FIG. 3 is a cross sectional view showing an embodiment of a principal part of a spindle motor according to the present invention;

FIG. 4 is a plan view showing a magnetic steel sheet;

FIG. 5 is a schematic view showing magnetic steel sheets being laminated, with a projection on one steel sheet is fitted to an indentation of another steel sheet for being riveted at a riveting portion;

FIG. 6 is a graph showing a comparison of consumed currents of motors having cores each formed with magnetic steel sheets having a different thickness; and

FIG. 7 is a graph showing a comparison of averaged consumed currents of motors having cores each formed with magnetic steel sheets having a different thickness.

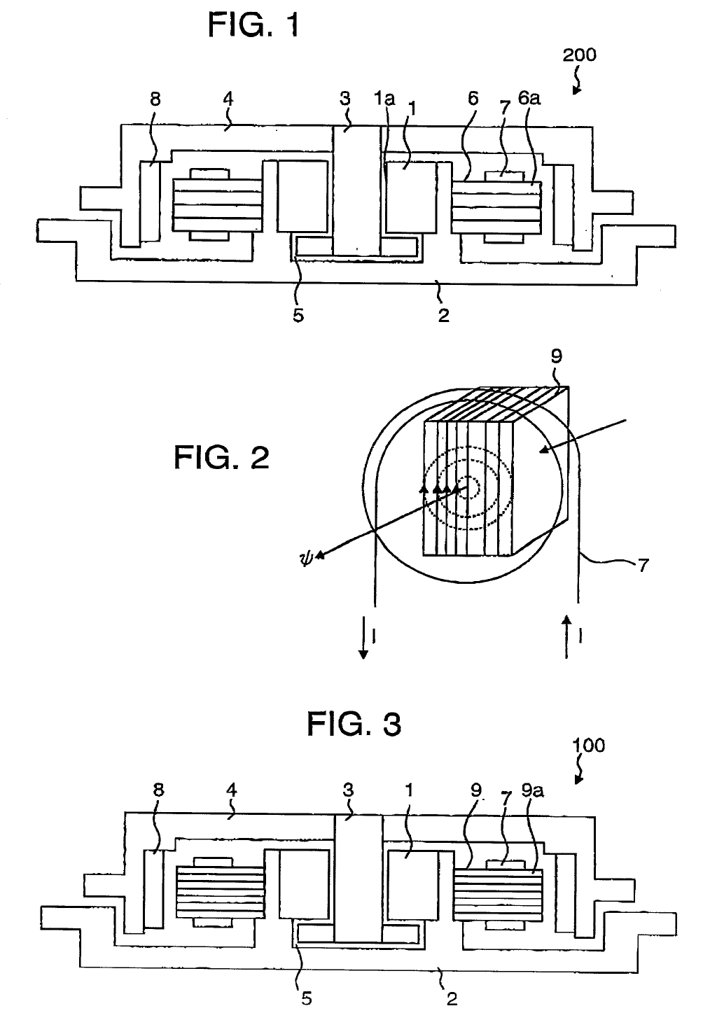

### DESCRIPTION OF THE PREFERRED EMBODIMENT

In the following, preferred embodiment of the present invention will be explained in detail with reference to the drawings. It is, however, to be understood that the present invention is not limited by the embodiment.

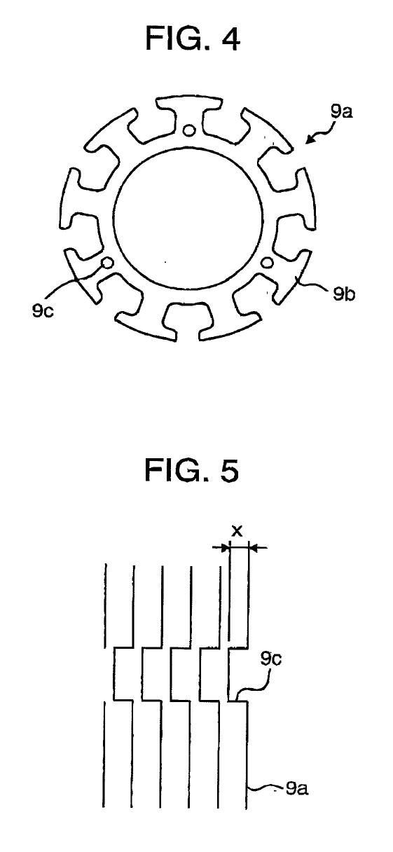

FIG. 3 is a cross sectional view showing a principal part of an embodiment of a hydraulic bearing motor according to the present invention. The spindle motor 100 shown in FIG. 3 is provided with a hydraulic bearing assembled with the following being taken as prime components, a sleeve (a support) 1 formed with a cylindrical shaft body inserting hole, a frame 2 securing the lower side of the sleeve 1, a cylindrical shaft body 3 having a cross sectional form of an inverted T and being inserted into a space formed by the shaft body inserting hole, the sleeve 1 and the frame 2, with a clearance being created between the shaft body 3 and an inner walls of the sleeve 1 and the frame 2, a hub 4 securely mounted on an upper portion of the shaft body 3, and oil 5 filling the above clearance.

In addition, the spindle motor 100 comprises a core 9 laminated with seven magnetic steel plates 9a as non-oriented magnetic steel sheets disposed on the periphery of the sleeve 1, a coil 7 wound onto the core 9, and a magnet 8 mounted on the hub 4 and positioned so as to face the core 9 and the coil 7. The spindle motor 100 functions so that a varying magnetic field generated by the core 9 and the coil 7 acts on the magnet 8 to rotate the hub 4 with resulting rotation of the shaft body 3.

FIG. 4 is a plan view showing a magnetic steel sheet. FIG. 5 is a schematic view showing magnetic steel sheets being laminated. The magnetic steel sheet 9a is a sheet formed in a doughnut-like shape with a thickness of 0.2 mm. On a periphery of the sheet, there are formed nine protrusions 9b, which are portions for winding the coil 7 around each thereof when the magnetic steel sheets 9a are laminated. On the steel sheet 9a, there are formed riveting portions 9c. At each of the riveting portions 9c, an indentation is provided on one side of the steel sheet to form a projection on the other side. As shown in FIG. 5, a depth of the indentation and a height of the projection at the riveting portion 9c are formed to have the same value X so that, when the magnetic steel sheets are laminated, the projection on one steel sheet is fitted to the indentation of another steel sheet for being riveted. Here, the riveting portions 9c are formed at three positions with a depth or a height X. The number of the riveting portions 9c, however, is not limited to this, but can be as many as required.

In the following, there are shown results of experiments for comparing consumed powers of motors having cores each formed with magnetic steel sheets 9a having a different thickness. The comparison was made on cores having total thickness equal to one another formed with ten 0.15 mm thick, seven 0.2 mm thick and four 0.35 mm thick magnetic steel sheets, respectively.

TABLE 1 is a list showing consumed currents and averaged value thereof with a standard deviation, the maximum value and the minimum value about samples of motors No. 1 to 9 in each of cases in which cores are formed with 0.15 mm thick, 0.2 mm thick and 0.35 mm thick magnetic steel sheets.

TABLE 1
(mA)

| Sheet | No. | | | | | | | | | Averaged | STD. | | |
|---|---|---|---|---|---|---|---|---|---|---|---|---|---|
| thickness | 1 | 2 | 3 | 4 | 5 | 6 | 7 | 8 | 9 | value | Deviation | Max. value | Min. value |
| Sheet thickness | 76.5 | 73.4 | 74.8 | 72.6 | 72.1 | 72.7 | 72.1 | 68.2 | 70.4 | 72.5 | 2.38 | 76.5 | 68.2 |
| 0.15 mm | | | | | | | | | | | | | |
| Sheet thickness | 78.8 | 76.1 | 78 | 75.8 | 73.6 | 75.2 | 74 | 69.5 | 72.4 | 74.8 | 2.85 | 78.8 | 69.5 |
| 0.2 mm | | | | | | | | | | | | | |
| Sheet thickness | 82 | 83.5 | 82.6 | 81.1 | 82.7 | 83.1 | 79.3 | 82.2 | 81.8 | 82.0 | 1.25 | 83.5 | 79.3 |
| 0.35 mm | | | | | | | | | | | | | |

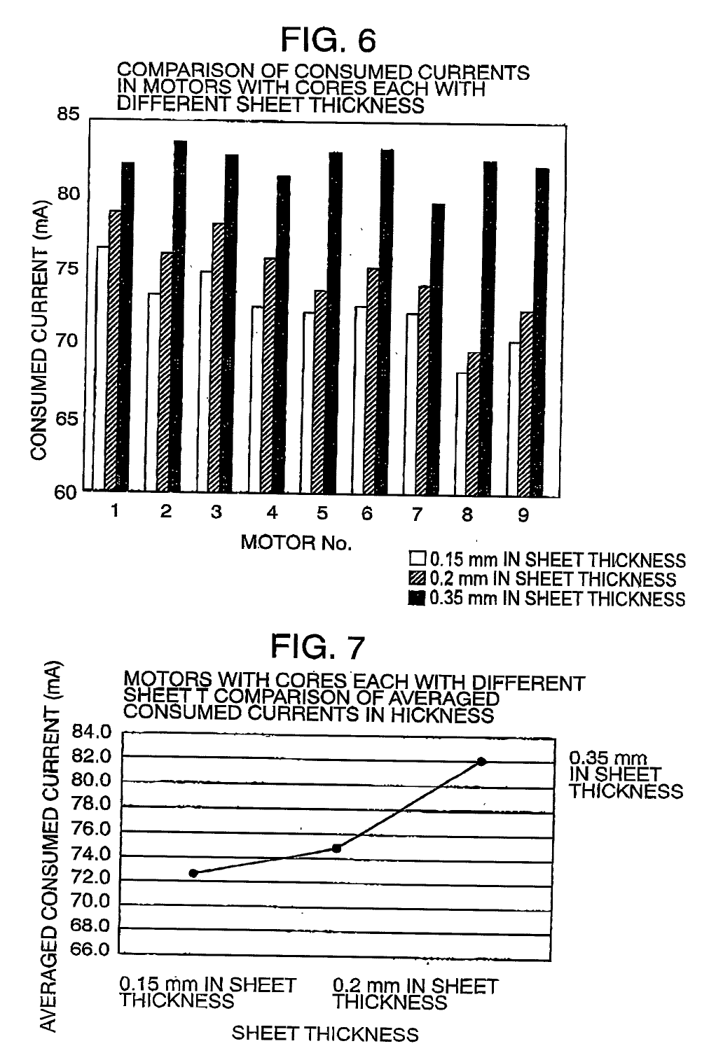

The results of the above comparison presented in TABLE 1 are shown in graphs in FIG. 6 and FIG. 7. FIG. 6 is a graph showing a comparison of consumed currents of motors having cores each formed with magnetic steel sheets having a different thickness. FIG. 7 is a graph showing a comparison of averaged consumed currents of motors having cores each formed with magnetic steel sheets having a different thickness. As shown in FIG. 6 and FIG. 7, it is found that current consumption is improved as the sheet thickness becomes thinner. Specifically, it is found that change in the sheet thickness from 0.35 mm to 0.2 mm improves current consumption by 8.8%. Moreover, it is found that change to 0.15 mm improves the current consumption by 11.6%.

On the other hand, in the current magnetic steel sheets used in the experiments, although strength of the steel sheet for riveting can be adequately ensured down to the thickness of 0.2 mm, the strength decreases for 0.15 mm thickness. Therefore it is particularly preferable to use a magnetic steel sheet with a thickness of around 0.2 mm.

Therefore, according to the embodiment, there is obtained a core which makes it possible to reduce consumed power so as to be suited for downsizing an HDD.

As explained in the foregoing, according to the present invention, it becomes possible to reduce consumed power of a spindle motor by reducing consumed current thereof to offer an effect of making it possible to provide the spindle motor as being suited for downsizing an HDD.

What is claimed is:

1. A spindle motor comprising:
a body of rotation rotating with an axis of rotation thereof being centered;
a magnet mounted on the body of rotation for making the body of rotation rotate by an action of a varying magnetic field;
a coil generating the varying magnetic field acting on the magnet; and
a core formed by laminating a plurality of doughnut-like magnetic steel sheets each with a plurality of protrusions provided on a periphery for winding wire of the coil,
the improvement wherein
the core with a specified thickness is formed by laminating thinnest possible magnetic steel sheets.

2. The spindle motor according to claim 1, wherein the thinnest possible magnetic steel sheet forming the core has a thickness of 0.15 mm to 0.35 mm.

3. The spindle motor according to claim 2, wherein the thinnest possible magnetic steel sheet has a thickness of about 0.2 mm.

4. The spindle motor according to claim 1, wherein the magnetic steel sheet is provided with a plurality of riveting portions at each of which an indentation is provided on one side of the steel sheet to form a projection on the other side, and at each of the riveting portions, the projection on one magnetic steel sheet is fitted to the indentation of another magnetic steel sheet for being riveted to thereby make up a laminated structure of the magnetic steel sheets for the core.

5. A core for a spindle motor wherein the core is a lamination of magnetic steel sheets each having a thickness of 0.15 mm to 0.35 mm.

6. A core for a spindle motor according to claim 5 wherein the magnetic steel sheet has a thickness of about 0.2 mm.

7. A method of manufacturing a spindle motor provided with a core formed by laminating a plurality of magnetic steel sheets, the method comprising the steps of:
forming a plurality of riveting portions on each of the magnetic steel sheets by forming at each of the riveting portions an indentation on one side of the steel sheet to form a projection on the other side;
at each of the riveting portions, fitting the projection on one magnetic steel sheet to the indentation of another magnetic steel sheet; and
laminating a plurality of the magnetic steel sheets one by one by riveting the indentation and the projection fitted thereto at each of the riveting portions for making up the core.
